(19) United States
(12) Patent Application Publication
(10) Pub. No.: US 2011/0129013 A1
(43) Pub. Date: Jun. 2, 2011

(54) METHOD AND APPARATUS FOR ADAPTIVELY DETERMINING COMPRESSION MODES TO COMPRESS FRAMES

(75) Inventors: Jia-Ming Chen, Nantou County (TW); Jia-Hau Yu, Yilan County (TW); Jian-Liang Luo, Tainan County (TW)

(73) Assignee: SUNPLUS CORE TECHNOLOGY CO., LTD., Hsinchu (TW)

(21) Appl. No.: 12/765,880

(22) Filed: Apr. 23, 2010

(30) Foreign Application Priority Data
Dec. 2, 2009 (TW) 98141223

(51) Int. Cl. H04N 7/26

(52) U.S. Cl. 375/240.02; 375/E07.125; 375/E07.127

(57) ABSTRACT

A method and an apparatus for adaptively determining compression modes to compress images are provided. When compressing a current frame in image data, the invention inquires a motion class corresponding to a reference frame of the current frame, in which the motion class is determined according to motion information of the reference frame. Next, a threshold set corresponding to the motion class is obtained and used to determine a compression mode for compressing each of a plurality of macroblocks in the current frame. Finally, the determined compression modes are used to compress corresponding macroblocks in the current frame.

### CROSS-REFERENCE TO RELATED APPLICATION

This application claims the priority benefit of Taiwan application serial no. 98141223, filed on Dec. 2, 2009. The entirety of the above-mentioned patent application is hereby incorporated by reference herein and made a part of specification.

### BACKGROUND OF THE INVENTION

1. Field of the Invention

This invention generally relates to a method and an apparatus for image compression, and more particularly, to a method and an apparatus for adaptively determining compression modes to compress frames.

2. Description of Related Art

For the bit rate control of frame processing, a traditional method is to calculate costs of rate distortion (RD) in all possible compression modes, and then select the one with lowest cost as the operation mode. However, the method requires much time for calculation and has high complexity for implementation, such that it is difficult to meet the requirements for real-time processing and cost reduction on hardware manufacture.

A known method to reform such problem focuses on the mobility of the frames. It utilizes the motion characteristics observed from the frames to reduce the number of compression modes that can be executed, and then selects a best compression mode from the compression modes after reduction by comparing the RD cost. The method obtains the related motion information according to the frame where the macroblock (MB) to be processed is located, and may be classified into two types: one method is to obtain the motion information by referencing the processed MBs on the left side, upper side, upper right side and upper left side; another method is to analyze and process the frame where the MB to be processed is located, in which the motion information of the entire frame are analyzed first and then the motion class of the current MB is determined according to the motion information. This method still needs to calculate the RD cost to determine the best compression mode. In addition, another known method is to simplify the operation of RD optimization (RDO), so as to speed up the entire flow of RDO determination.

The aforesaid methods still require calculating the RD cost to determine the compression mode, and therefore cost much time for calculation and raise relatively high complexity for implementation. Meanwhile, these methods perform the compression by referencing the related information obtained from the frame where the MB is located. Therefore, before the entire frame is fully analyzed, the information that can be obtained is limited to the processed MB, which is incomplete. As a result, although the method obtains the improvement on execution speed, it still causes the reduction on compression quality. On the other hand, if it is required to reference the information of entire frame, additional time is required to perform a complete analysis on the frame, which may yield to time.

Moreover, regarding aforesaid method for speeding up the process by means of simply modifying RDO operation, the improvements on the time for execution and on the complexity for implementation are still limited. It can be known from the above that the conventional methods only focus on applying input frames with high quality to improving the compression ratio without considering the thermal noise carried by the frames from the camera. Therefore, the improvement on compression ratio still faces obstacles in practice.

### SUMMARY OF THE INVENTION

The invention provides a method for adaptively determining compression modes to compress frames, in which a motion class of a current frame is determined according to the motion degree of the reference frame of the current frame, so as to adaptively determine the compression modes for compressing the macroblocks in the current frame.

The invention provides an apparatus for adaptively determining compression modes to compress frames, which determines a threshold set according to the motion degree of a reference frame of a current frame and applies the same to the compression decision process so as to speed up the process of image compression.

The invention provides a method for adaptively determining compression modes to compress frames, suitable for compressing a plurality of frames in image data. The method inquires a motion class corresponding to a reference frame of a current frame when compressing the current frame in the image data, in which the motion class is determined according to the motion information of the reference frame. Then, the method inquires a threshold set corresponding to the motion class, and determines the compression mode for compressing each of a plurality of macroblocks in the current frame according to the threshold set. Finally, the method compresses the macroblocks in the current frame by using the determined compression modes.

The invention provides an apparatus for adaptively determining compression modes to compress frames, which comprises a motion degree classification module, a compression mode determination module and a data compression module. The motion degree classification module inquires a motion class corresponding to a reference frame of a current frame to be processed in the image data and inquires a threshold set corresponding to a motion class, in which the motion class is determined according to the motion information of the reference frame. The compression mode determination module determines a compression mode for compressing each of the macroblocks in the current frame according to the threshold set obtained by the motion degree classification module. The data compression module compresses the macroblocks in the current frame by using the compression modes determined by the compression mode determination module.

As described above, the method and the apparatus for adaptively determining compression modes to compress frames of the present invention determine the motion class of the current frame according to the motion degree of the reference frame and select a threshold set according to the motion class. Accordingly, by applying the thresholds in the threshold set to the compression decision process, the compression speed can be improved by adaptively determining the compression modes.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a block diagram of an apparatus for adaptively determining compression modes to compress frames according to a first embodiment of the invention.

FIG. 2 shows a flowchart of a method for adaptively determining compression modes to compress frames according to the first embodiment of the invention.

FIG. 3 shows a flowchart of a method for determining motion macroblocks according to the first embodiment of the invention.

FIG. 4 shows a block diagram of the compression mode determination module according to the second embodiment of the invention.

FIG. 5 shows a flowchart of method for determining the compression mode according to the second embodiment of the invention.

### DESCRIPTION OF EMBODIMENTS

The invention defines a plurality of motion classes and the compression parameters suitable for those motion classes according to the motion degree of the frame to be processed, so as to establish a motion class table. When compressing image data, the invention inquires the motion class table by referencing a motion class corresponding to a reference frame, so as to extract the compression parameters suitable for compressing the current frame and apply the same to the decision process of the compression mode. Accordingly, the compression is speeded up and the noise interference is reduced. In addition, in the process of compressing a frame, the invention also generates motion degree information of the frame, which can be used for determining the motion class of the frame and used as the reference to compress following frames.

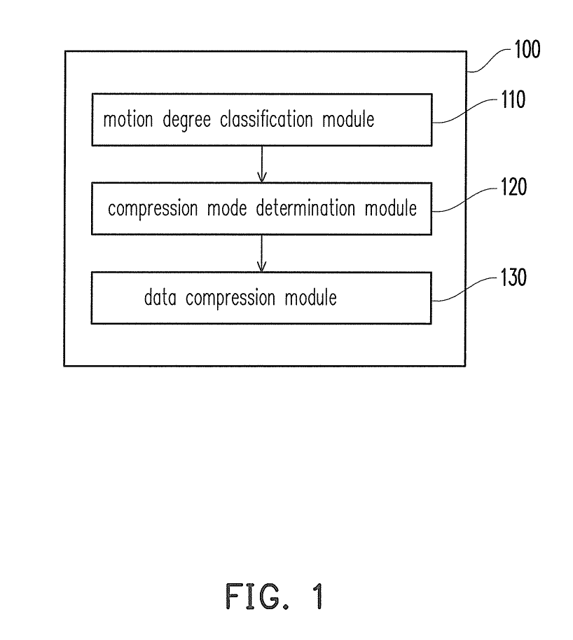

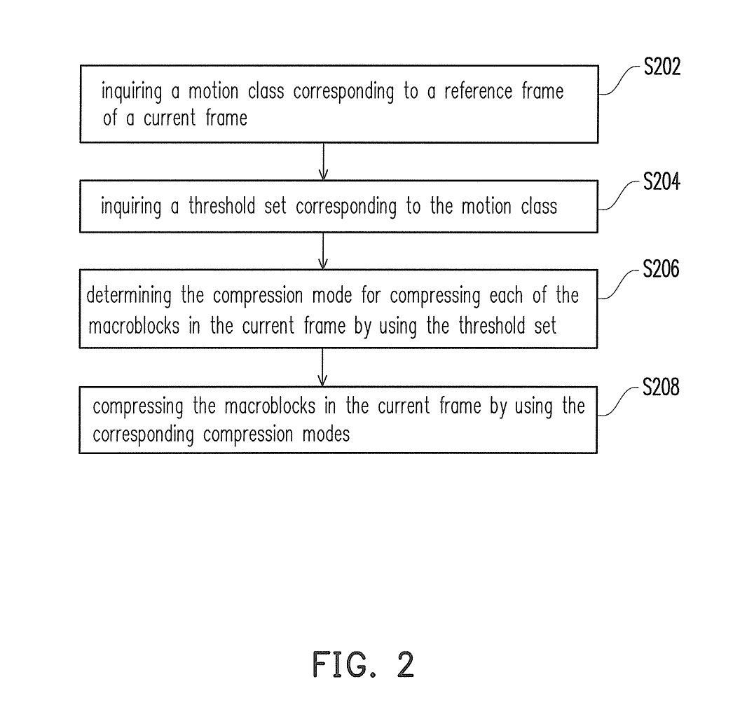

FIG. 1 shows a block diagram of an apparatus for adaptively determining compression modes to compress frames according to a first embodiment of the invention. FIG. 2 shows a flowchart of a method for adaptively determining compression modes to compress frames according to the first embodiment of the invention. Referring to FIG. 1 and FIG. 2, the image compression apparatus 100 comprises a motion degree classification module 110, a compression mode determination module 120 and a data compression module 130, and is used for determining the compression mode of each of the frames in the image data and compressing the frame data using the determined compression modes. The function of each of the elements in the image compression apparatus 100 and the detailed steps of the image compression method will be described with reference to the figures.

When the image compression apparatus 100 compresses a certain frame in the image data, the motion degree classification module 110 inquires a motion class corresponding to a reference frame of the current frame first (step S202), in which the motion class is, for example, determined according to the motion information of the reference frame. In detail, the embodiment uses a ratio or a distribution of the area occupied by the motion macroblocks in the reference frame as the motion information of the reference frame. When performing the compression, the motion degree classification module 110 inquires a motion class table by using the motion information as an index, so as to find the motion class corresponding to the reference frame.

In addition, the motion degree classification module 110 also inquires a threshold set corresponding to the motion class (step S204) when inquiring the motion class of the reference frame. In detail, in the present embodiment, a threshold set is set for each of the motion classes, in which the thresholds in the threshold set are all the best values to be used under the corresponding motion class. The threshold sets are established in a table which uses the motion class as the index. Thereafter, the threshold set corresponding to the motion class can be obtained by providing the motion class of the reference frame and looking up the table by using the motion class as the index, and the obtained threshold set is then used in the compression process of the current frame.

After the motion class of the reference frame is determined and the best threshold set of the motion class is obtained, the compression mode determination module 120 then applies the threshold set to the decision process of the compression mode, so as to determine the compression mode for compressing each of a plurality of macroblocks in the current frame (step S206).

For example, the compression mode determination module 120 calculates a first residual operation value between the current macroblock to be processed in the current frame and the reference macroblock in the reference frame having a position corresponding to a position of the current macroblock. The first residual operation value refers to, for example, a sum of absolute difference (SAD) or a sum of squared difference (SSD), which is not limited to the embodiment. Then, the first residual operation value is compared with a residual threshold to determine whether to regard the first residual operation value as a result caused by the noise. If the first residual operation value is less than the residual threshold, it is determined that the first residual operation value is the result caused by the noise. Therefore, the first residual operation value is set to zero, and meanwhile a 16×16 inter-frame compression mode is assigned as the compression mode for compressing the current macroblock. The aforesaid threshold scheme can effectively increase the compression ratio and reduce the adverse effect on the quality of the compression frame due to the thermal noise.

Back to the step S230, after the compression mode determination module 120 determines the compression modes for compressing the macroblocks in the current frame, the data compression module 130 compresses the macroblocks in the current frame by using corresponding compression modes (step S208).

It is noted that when compressing the current frame, the compression mode determination module 120, for example, calculates the motion information of the current frame, determines the motion class corresponding to the current frame accordingly and uses the same as the reference for compressing a next frame. In detail, the compression mode determination module 120 may, for example, determine whether each of the macroblocks in the current frame is a motion macroblock by a motion macroblock determination module (not shown) and calculate a number of motion macroblocks in the current frame or a ratio occupied by the motion macroblocks in the current frame by a motion information calculation module (not shown), and then use the calculation result as the motion information.

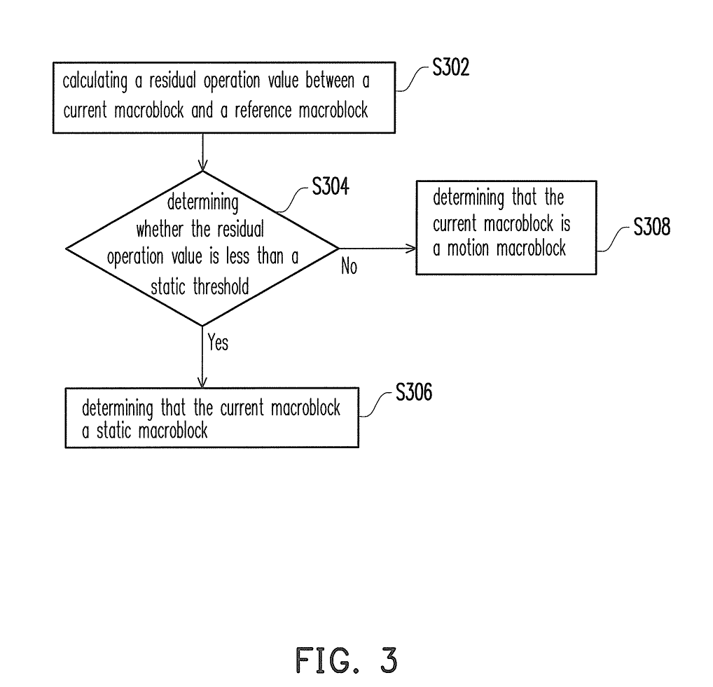

For example, FIG. 3 shows a flowchart of a method for determining motion macroblocks according to the first embodiment of the invention. Referring to FIG. 3, in the present embodiment, whether a current block is a motion macroblock is determined according to related information between the current macroblock in the current frame and a reference macroblock in a reference frame having a position corresponding to a position of the current macroblock. First, a residual operation value (e.g. SAD_Silent) between the current macroblock and the reference macroblock is calculated (step S302). Then, the residual operation value is compared with a static threshold (e.g. Thresh_Silent) to determine whether the residual operation value is less than a static threshold (step S304) and accordingly determine whether the current macroblock is a motion macroblock. The residual operation value may, for example, refer to a sum of residual value (SAD) or a sum of squared residual value (SSD), which is not limited to the embodiment. If the first residual operation value is less than the static threshold, then the current macroblock is determined as a static macroblock (step S306). Otherwise, the current macroblock is determined as a motion macroblock (step S308).

The motion information calculated by the compression mode determination module 120 is output to the motion degree classification module 110, and accordingly the motion degree classification module 110 determines the motion class corresponding to the current frame and uses the same as the reference for compressing a next frame.

To sum up, in the present embodiment, the compression modes of each of the frames can be derived from the motion degree of the reference frame thereof, such that the time and the cost for respectively calculating each of the compression modes can be reduced. As a result, the design complexity of the entire compression process and the requirement for the calculation power can be reduced.

A second embodiment of the invention applies multiple compression thresholds to the decision of compression mode of the first embodiment, so as to further eliminate the frame noise, enhance the compression on static frames and adjust the weights of the inter-frame prediction or the intra-frame prediction. For such purposes, the invention finds out a best compression threshold for each motion class and applies the same to the decision process of the compression mode, so as to eliminate the noise and simplify the compression process. The definitions of the thresholds are as follows.

1. Residual threshold (Threshold_A): When compressing a current macroblock in the current frame, the SAD value between the current macroblock and the reference macroblock in the reference frame having the position corresponding to the position of the current macroblock is calculated; on the other hand, an inter-frame prediction is performed and a SAD value is calculated by using the best reference frame searched by the search window of the inter-frame prediction. If the difference between the above two SAD values is less than the residual threshold Threshold_A, the current macroblock is regarded as being static and the motion vector thereof is regarded as zero. The threshold scheme can efficiently correct the misjudgement on the motion vector due to the thermal noise or poor frame quality.

2. Motion vector threshold Threshold_B: The value of motion vector of the current macroblock in the inter-frame prediction is compared with the motion vector threshold Threshold_B. If the value of the motion vector is less than the motion vector threshold Threshold_B, the reference macroblock to be referenced for compressing the current macroblock is forced to be changed to the reference macroblock in the reference frame having the position corresponding to the position of the current macroblock (i.e. the motion vector is regarded as zero). The threshold scheme can efficiently correct the misjudgement on the motion vector due to the thermal noise or poor frame quality.

3. Residual threshold Threshold_C: The SAD value between the current macroblock and the reference macroblock under the best compression mode obtained by performing the inter-frame prediction is compared with the residual threshold Threshold_C. If the SAD value is less than the residual threshold Threshold_C, the compression mode is regarded as meeting the requirement and no further intra-frame prediction is needed. The threshold scheme can efficiently speed up the compression without harming the compression ratio and the compressed frame quality.

4. Residual threshold Threshold_D: The residual threshold Threshold_D is used to adjust the priority of the inter-frame compression mode and the intra-frame compression mode, so as to select the compression mode with better compression ratio.

5. Residual threshold Threshold_E: The residual operation value (i.e. the first residual operation value as described above) between the current macroblock to be processed in the current frame and the reference macroblock in the reference frame having the position corresponding to the position of the current macroblock is calculated and compared with the residual threshold Threshold_E, so as to determine whether to regard the residual operation value as a result caused by the noise. If the residual operation value is less than the residual threshold Threshold_E, then the residual operation value is regarded as the result caused by the noise, and accordingly set to zero. The threshold scheme can effectively increase the compression ratio and reduce the adverse effect on the compression frame quality due to the thermal noise.

By applying the aforesaid thresholds to the compression mode determination module 120 in the first embodiment, the compression mode with best compression ratio for the currently processed macroblock can be selected. Embodiments are given below for further illustration.

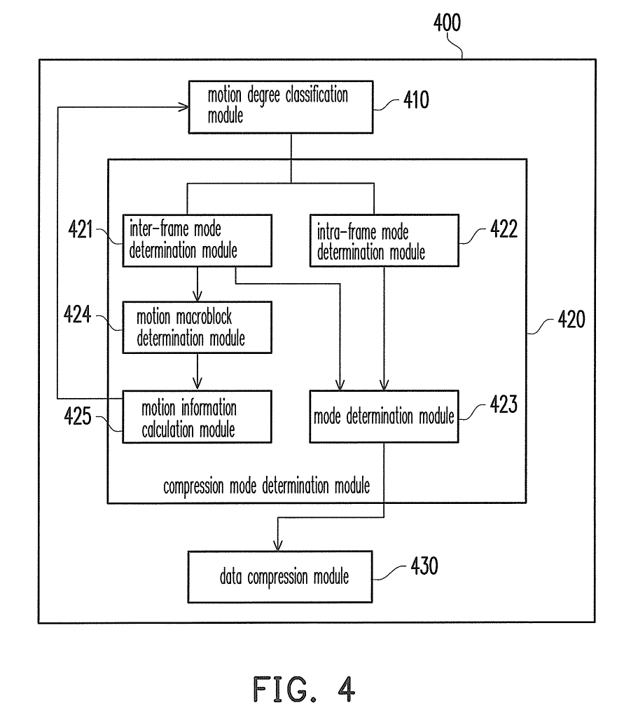

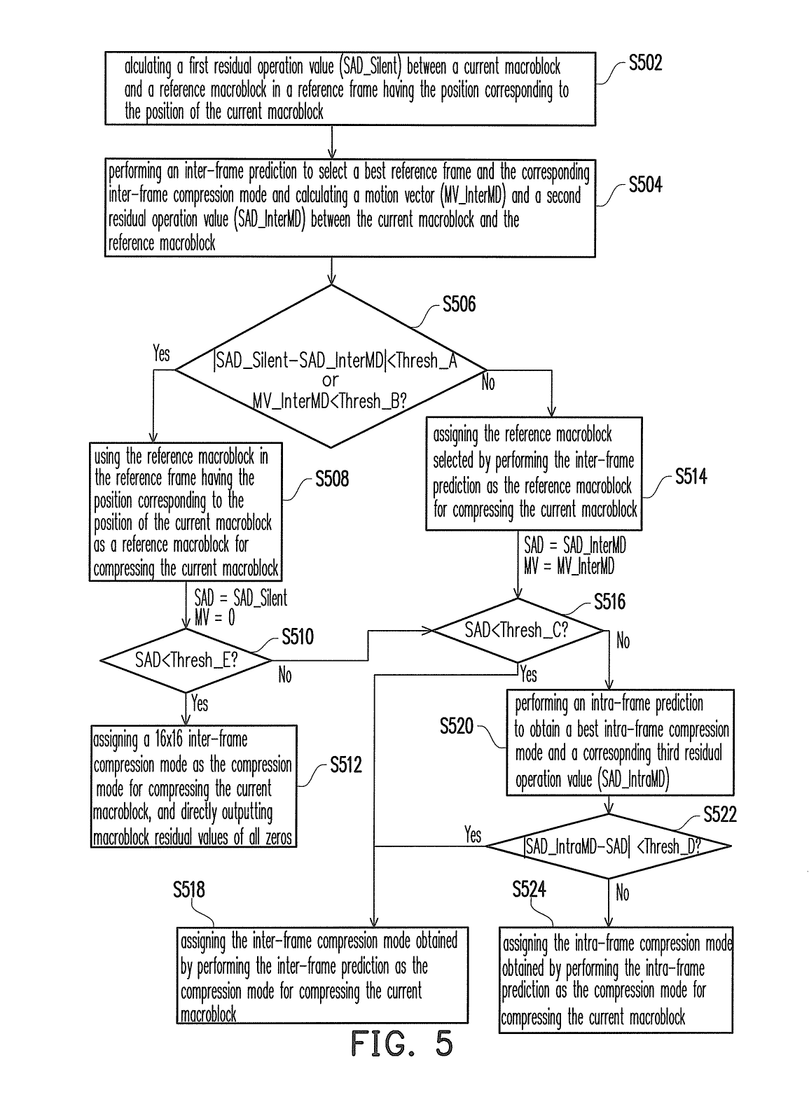

FIG. 4 shows a block diagram of the compression mode determination module according to a second embodiment of the invention. FIG. 5 shows a flowchart of a method for determining the compression mode according to the second embodiment of the invention. Referring to FIG. 4 and FIG. 5, the image compression apparatus 400 comprises a motion degree classification module 410, a compression mode determination module 420 and a data compression module 430. The input end of the compression mode determination module 420 mainly receives the macroblock to be compressed and the reference macroblock required for generating the prediction macroblock corresponding to the macroblock to be compressed, and further receives the threshold set looked up by the motion degree classification module 410. According to the three types of the input data, the compression mode determination module 420 can select the compression mode best for the compression ratio with acceptable frame quality, and may directly generate the residual of the macroblock under certain conditions.

The compression mode determination module 420 may be divided into an inter-frame mode determination module 421, an intra-frame mode determination module 422, a mode determination module 423, a motion macroblock determination module 424 and a motion information calculation module 425. The function of each of the elements of the compression mode determination module 420 and the detailed steps of the compression mode determination method are described below with reference to the figures.

First, the inter-frame mode determination module 421 calculates a first residual operation value (SAD_Silent) between the current macroblock and the reference macroblock in the reference frame (i.e. a complete reference macroblock without being partitioned) having the position corresponding to the position of the current macroblock (step S502).

In addition, the inter-frame mode determination module 421 also performs an inter-frame prediction to select a best reference macroblock relative to the current macroblock in the current frame from a plurality of macroblocks in the reference frame provided from the outside and select a corresponding inter-frame compression mode (MbType_InterMD), and then calculates a motion vector (MV_InterMD) and a second residual operation value (SAD_InterMD) between the current macroblock and the reference macroblock (step S504).

Then, the mode determination module 423 determines whether an absolute value of difference between the first residual operation value and the second residual operation value is less than the residual threshold Thresh_A in the threshold set or the motion vector is less than the motion vector threshold Thresh_B in the threshold set (step S506). If the mode determination module 423 determines the absolute value of difference is less than the residual threshold Thresh_A or the motion vector is less than the motion vector threshold Thresh_B, then the mode determination module 423 forces to select the reference macroblock in the reference frame having the position corresponding to the position of the current macroblock as the reference macroblock for compressing the current macroblock and sets the motion vector value to zero (step S508).

Next, the mode determination module 423 determines whether the first residual operation value (SAD_Silent) is less than the residual threshold Thresh_E in the threshold set (step S510). If the first residual operation value is less than the residual threshold Thresh_E, a 16×16 inter-frame compression mode (i.e. Inter 16×16) is assigned as the compression mode for compressing the current macroblock, and macroblock residual values of all zeros are output directly (step S512), that is, no further calculation for the residual values is needed.

If the first residual operation value is not less than the residual threshold Thresh_E, the mode determination module 423 further determines whether the first residual operation value is less than the residual threshold Thresh_C in the threshold set (step S516). If the first residual operation value is less than the residual threshold Thresh_C, the mode determination module 423 assigns the inter-frame compression mode (MbType_InterMD) obtained by performing the inter-frame prediction as the compression mode for compressing the current macroblock (step S518).

If the first residual operation value is not less than the residual threshold Thresh_C, the intra-frame mode determination module 422 performs an intra-frame prediction to obtain a best intra-frame compression mode (MbType_IntraMD) and a corresponding third residual operation value (SAD_IntraMD) (step S520).

Finally, the mode determination module 423 determines whether an absolute value of difference between the third residual operation value (SAD_IntraMD) and the first residual operation value (SAD_Silent) is less than the residual threshold Thresh_D in the threshold set (step S522). If the absolute value of difference is less than the residual threshold Thresh_D, the mode determination module 423 assigns the inter-frame compression mode (MbType_InterMD) obtained by performing the inter-frame prediction as the compression mode for compressing the current macroblock (step S518); otherwise, the mode determination module 423 assigns the intra-frame compression mode (MbType_IntraMD) obtained by performing the intra-frame prediction as the compression mode for compressing the current macroblock (step S522).

On the other hand, in the step S506, if the mode determination module 423 determines the absolute value of difference between the first residual operation value and the second residual operation value is not less than the residual threshold Thresh_A and the motion vector is not less than the motion vector threshold Thresh_B, the mode determination module 423 assigns the reference macroblock selected by performing the inter-frame prediction as the reference macroblock for compressing the current macroblock, and continues to determine whether the second residual absolute value (SAD_InterMD) is less than the residual threshold Thresh_C in the threshold set (step S514). If the second residual operation value is less than the residual threshold Thresh_C, the mode determination module 423 assigns the inter-frame compression mode (MbType_InterMD) obtained by performing the inter-frame prediction as the compression mode for compressing the current macroblock (step S516).

If the second residual operation value is not less than the residual threshold Thresh_C, the intra-frame mode determination module 422 performs the intra-frame prediction to obtain a best intra-frame compression mode (MbType_IntraMD) and a corresponding third residual operation value (SAD_IntraMD) (step S518).

Finally, the mode determination module 423 determines whether an absolute value of difference between the third residual operation value and the second residual operation value (SAD_InterMD) is less than the residual threshold Thresh_D in the threshold set (step S520). If the absolute value is less than the residual threshold Thresh_D, the mode determination module 423 assigns the inter-frame compression mode (MbType_InterMD) obtained by the inter-mode determination module 421 performing the inter-frame prediction as the compression mode for compressing the current macroblock (step S516); otherwise, the mode determination module 423 assigns the intra-frame compression mode (MbType_IntraMD) obtained by the intra-frame mode determination module 422 performing the intra-frame prediction as the compression mode for compressing the current macroblock (step S522).

It is noted that, the first residual operation value (SAD_Silent) calculated by the inter-frame mode determination module 421 may be used for determining whether the current macroblock is a motion macroblock and further used for determining the motion class of the current frame. In detail, when the inter-frame mode determination module 421 calculates the first residual operation value (SAD_Silent) between the current macroblock and the reference macroblock in the reference frame having the position corresponding to the position of the current macroblock in step S510, the inter-frame mode determination module 421 outputs the first residual operation value to the motion macroblock determination module 424. The motion macroblock determination module 424 compares the first residual operation value with a static threshold (Thresh_Silent) to determine whether the current macroblock is a motion macroblock. If the first residual operation value is less than the static threshold, then the motion macroblock determination module 424 determines that the current macroblock is a static macroblock; otherwise, the motion macroblock determination module 424 determines that the current macroblock is a motion macroblock. At this moment, the motion information calculation module 425 may perform an accumulation on a global variable (Move_MB_Count). The value of the global variable is reset to zero before the image compression apparatus 400 processes each frame. After all the macroblocks in the frame are compressed, the accumulated global variable is output to the motion degree classification module 410 for determining the motion class of the frame.

To sum up, the method and the apparatus for adaptively determining compression modes to compress frames of the invention use the motion classification result of the reference frame as the motion class of the currently processed frame and inquire the thresholds corresponding to the motion class. By applying the thresholds to the decision process of the compression mode, the invention is able to eliminate the noise, enhance the compression for static frames and reduce large sum of time for compression, such that the entire compression process may achieve lower computation requirement, less design complexity and good compression ratio.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adaptively determining compression mode to compress frames, suitable for compressing a plurality of frames in image data, the method comprising:
inquiring a motion class corresponding to a reference frame of a current frame when compressing the current frame in the image data, wherein the motion class is determined according to motion information of the reference frame;
inquiring a threshold set corresponding to the motion class;
determining a compression mode for compressing each of a plurality of macroblocks in the current frame according to the threshold set;
compressing the macroblocks in the current frame by using the corresponding compression modes.

2. The method of claim 1, wherein the step of determining the motion class according to the motion information of the reference frame comprises:
inquiring a motion class table by using the motion information as an index to find the motion class corresponding to the reference frame.

3. The method of claim 2, wherein the step of inquiring the threshold set corresponding to the motion class comprises:
inquiring the motion class table by using the motion information as the index to find the threshold set corresponding to the motion information.

4. The method of claim 1, further comprising:
calculating the motion information of the current frame; and
determining the motion class corresponding to the current frame according to the motion information and using the same as a reference for compressing a next frame.

5. The method of claim 4, wherein the step of calculating the motion information of the current frame comprises:
determining whether each of the macroblocks in the current frame is a motion macroblock; and
calculating a number of the motion macroblocks in the current frame or a ratio occupied by the motion macroblocks in the current frame and using the same as the motion information.

6. The method of claim 5, wherein the step of determining whether each of the macroblocks in the current frame is the motion macroblock comprises:
determining whether the current block is the motion macroblock according to related information between a current macroblock in the current frame and a reference macroblock in the reference frame having a position corresponding to a position of the current macroblock or between the current macroblock and an adjacent macroblock in the current frame.

7. The method of claim 6, wherein the step of determining whether the current macroblock is the motion macroblock according to the related information between the current macroblock and the reference macroblock comprises:
calculating a first residual operation value between the current macroblock and the reference macroblock in the reference frame having the position corresponding to the position of the current macroblock;
determining whether the first residual operation value is less than a static residual threshold;
determining the current macroblock is a static macroblock if the first residual operation value is less than the static residual threshold; and
determining the current macroblock is the motion macroblock if the first residual operation value is not less than the static residual threshold.

8. The method of claim 7, wherein the step of determining each of the compression modes of the macroblocks in the current frame according to the threshold set comprises:
determining whether the calculated first residual operation value is less than a first residual threshold in the threshold set; and
setting the first residual operation value between the current macroblock and the corresponding reference macroblock to zero, and assigning a 16×16 inter-frame compression mode as a compression mode for compressing the current macroblock if the calculated first residual operation value is less than the first residual threshold.

9. The method of claim 8, wherein the first residual operation value comprises a sum of residual value or a sum of squared residual value.

10. The method of claim 1, wherein the step of determining each of the compression modes of the macroblocks in the current frame according to the threshold set comprises:
a. calculating a first residual operation value between the current macroblock and the reference macroblock in the reference frame having a position corresponding to a position of the current macroblock;
b. performing an inter-frame prediction to select a best reference macroblock corresponding to a current macroblock in the current frame from a plurality of macroblocks in the reference frame and select an inter-frame compression mode corresponding to the best reference macroblocks, and calculating a motion vector and a second residual operation value between the current macroblock and the reference macroblock; and
c. determining whether an absolute value of a difference between the first residual operation value and the second residual operation value is less than a second residual threshold in the threshold set or whether the motion vector is less than a motion vector threshold in the threshold set;
c1. forcing to select the reference macroblock in the reference frame having a position corresponding to a position of the current macroblock as the reference macroblock for compressing the current macroblock if the absolute value is less than the second residual threshold or the motion vector is less than the motion vector threshold; and
c2. using the reference macroblock found by the inter-frame prediction as the reference macroblock for compressing the current macroblock if the absolute value is not less than the second residual threshold and the motion vector is not less than the motion vector threshold.

11. The method of claim 10, wherein after the step c1, the method further comprises:
d. determining whether the second residual operation value is less than a first residual threshold in the threshold set; and
d1. setting the first residual operation value between the current macroblock and the corresponding reference macroblock to zero, and assigning a 16×16 inter-frame compression mode as a compression mode for compressing the current macroblock if the second residual operation value is less than the first residual threshold.

12. The method of claim 11, wherein in the step d, if the second residual operation value is not less than the first residual threshold, the method further comprises:
d2. determining whether the second residual operation value is less than a third residual threshold in the threshold set;
assigning the inter-frame compression mode obtained by performing the inter-frame prediction as the compression mode for compressing the current macroblock if the second residual operation value is less than the third residual threshold;
performing an intra-frame prediction to obtain a best intra-frame compression mode and a corresponding third residual operation value, and determining whether an absolute value of a difference between the third residual operation value and the first residual operation value is less than a fourth residual threshold in the threshold set if the second residual operation value is not less than the third residual threshold;
assigning the inter-frame compression mode obtained by performing the inter-frame prediction as the compression mode for compressing the current macroblock if the absolute value is less than the fourth residual threshold; and
assigning the intra-frame compression mode obtained by performing the intra-frame prediction as the compression mode for compressing the current macroblock if the absolute value is not less than the fourth residual threshold.

13. The method of claim 10, wherein after the step c2, the method further comprises:
e. determining whether the second residual operation value is less than a third residual threshold in the threshold set;
assigning the inter-frame compression mode obtained by performing the inter-frame prediction as the compression mode for compressing the current macroblock if the second residual operation value is less than the third residual threshold;
performing an intra-frame prediction to obtain a best intra-frame compression mode and a corresponding third residual operation value, and determining whether an absolute value of difference between the third residual operation value and the second residual operation value is less than a fourth residual threshold in the threshold set if the second residual operation value is not less than the third residual threshold;
assigning the inter-frame compression mode obtained by performing the inter-frame prediction as the compression mode for compressing the current macroblock if the absolute value of difference between the third residual operation value and the second residual operation value is less than the fourth residual threshold; and
assigning the intra-frame compression mode obtained by performing the intra-frame prediction as the compression mode for compressing the current macroblock if the absolute value of difference is not less than the fourth residual threshold.

14. An apparatus for adaptively determining compression mode to compress frames, comprising:
a motion degree classification module, for inquiring a motion class corresponding to a reference frame of a current frame in image data to be processed and a threshold set corresponding to the motion class, wherein the motion class is determined according to motion information of the reference frame;
a compression mode determination module, for determining a compression mode for compressing each of a plurality of macroblocks in the current frame according to the threshold set obtained by the motion degree classification module; and
a data compression module, for compressing the macroblocks in the current frame by using the corresponding compression modes determined by the compression mode determination module.

15. The apparatus of claim 14, wherein the motion degree classification module inquires a motion class table by using the motion information as an index to find the motion class corresponding to the reference frame.

16. The apparatus of claim 15, wherein the motion degree classification module further inquires the motion class table by using the motion information as the index to find the threshold set corresponding to the motion information.

17. The method of claim 14, wherein the compression mode determination module comprises:
an inter-frame mode determination module, for calculating a first residual operation value between the current macroblock and the reference macroblock in the reference frame having a position corresponding to a position of the current macroblock, and performing an inter-frame prediction to select a best reference macroblock corresponding to a current macroblock in the current frame from a plurality of macroblocks in the reference frame and selecting an inter-frame compression mode corresponding to the best reference macroblock, and calculating a motion vector and a second residual operation value between the current macroblock and the reference macroblock;
an intra-frame mode determination module, for performing an intra-frame prediction to obtain a best intra-frame compression mode for the current macroblock and a corresponding third residual operation value; and
a mode determination module, for determining whether an absolute value of a difference between the first residual operation value and the second residual operation value is less than a second residual threshold in the threshold set or whether the motion vector is less than a motion vector threshold in the threshold set, wherein
if the absolute value is less than the second residual threshold or the motion vector is less than the motion vector threshold, the mode determination module forces to select the reference macroblock in the reference frame having the position corresponding to the position of the current macroblock as the reference macroblock for compressing the current macroblock; and
if the absolute value is not less than the second residual threshold and the motion vector is not less than the motion vector threshold, the mode determination module uses the reference macroblock found by the inter-frame prediction as the reference macroblock for compressing the current macroblock.

18. The apparatus of claim 17, wherein the compression mode determination module further comprises:
a motion macroblock determination module, for determining whether each of the macroblocks in the current frame is a motion macroblock; and
a motion information calculation module, for calculating a number of the motion macroblocks in the current frame or a ratio occupied by the motion macroblocks in the current frame and using the same as the motion information.

19. The apparatus of claim 18, wherein the motion macroblock determination module receives the first residual operation value between the current macroblock and the reference macroblock calculated by the inter-frame mode determination module, and compares the first residual operation value with a static threshold to determine whether the macroblock in the current frame is a motion macroblock.

20. The apparatus of claim 19, wherein the first residual operation value comprises a sum of residual value or a sum of squared residual value.

21. The apparatus of claim 17, wherein when determining the absolute value of difference between the first residual operation value and the second residual operation value is less than the second residual threshold or determining the motion vector is less than the motion vector threshold, the mode determination module further comprises:
determining whether the second residual operation value is less than a first residual threshold in the threshold set; and
setting the first residual operation value between the current macroblock and the corresponding reference macroblock to zero, and assigning a 16×16 inter-frame compression mode as a compression mode for compressing the current macroblock if the calculated second residual operation value is less than first residual threshold.

22. The apparatus of claim 21, wherein when determining the second residual operation value is not less than the first residual threshold, the mode determination module further comprises:
determining whether the second residual operation value is less than a first residual threshold in the threshold set;
setting the first residual operation value between the current macroblock and the corresponding reference macroblock to zero, and assigning a 16×16 inter-frame compression mode as a compression mode for compressing the current macroblock if the second residual operation value is less than the first residual threshold;
determining whether an absolute value of a difference between the third residual operation value and the first residual operation value is less than a fourth residual operation value in the threshold set if the second residual operation value is not less than the first residual threshold;
assigning the inter-frame compression mode obtained by performing the inter-frame prediction as the compression mode for compressing the current macroblock if the absolute value is less than the fourth residual threshold; and
assigning the intra-frame compression mode obtained by performing the intra-frame prediction as the compression mode for compressing the current macroblock if the absolute value is not less than the fourth residual threshold.

23. The apparatus of claim 17, wherein when determining the absolute value is not less than the second residual threshold and the motion vector is not less than the motion vector threshold, the mode determination module further comprises:
determining whether the second residual operation value is less than a third residual threshold in the threshold set;
assigning the inter-frame compression mode obtained by performing the inter-frame prediction as the compression mode for compressing the current macroblock if the second residual operation value is less than the third residual threshold;
determining whether an absolute value of a difference between the third residual operation value and the second residual operation value is less than a fourth residual operation value in the threshold set if the second residual operation value is not less than the third residual threshold;
assigning the inter-frame compression mode obtained by performing the inter-frame prediction as the compression mode for compressing the current macroblock if the absolute value is less than the fourth residual threshold; and
assigning the intra-frame compression mode obtained by performing the intra-frame prediction as the compression mode for compressing the current macroblock if the absolute value is not less than the fourth residual threshold.
